(19) United States
(12) Patent Application Publication
(10) Pub. No.: US 2009/0320849 A1
(43) Pub. Date: Dec. 31, 2009

(54) Anti-Viral Face Mask and Filter Material

(76) Inventor: Kimberly Biedermann, (US)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 12/374,104

(22) PCT Filed: Jul. 16, 2007
(86) PCT No.: PCT/EP07/57298

§ 371 Date: Jan. 16, 2009

(30) Foreign Application Priority Data
Jul. 18, 2006 (GB) 0614251.7
Apr. 2, 2007 (GB) 0706435.5

(51) Int. Cl. A62B 18/02; C08K 5/092; C08L 67/00; B01D 53/22; B05D 5/00

(52) U.S. Cl. 128/206.28; 524/320; 524/599; 96/11; 96/13; 95/45; 427/2.3

(57) ABSTRACT

A face mask comprising a filter material being a fibrous substrate, especially non-woven polypropylene or polyester, having an acidic polymer, especially of the Carbopol or Gantres type, deposited on the fibres. The mask has an anti-viral activity against inhaled or exhaled air. A filter material suitable for such a mask, and a process for making it are also described.

This invention relates to a novel device being an oral and/or nasal air filter able to remove and neutralize harmful virus from inhaled air contaminated with such virus, and from contaminated air exhaled from patients infected with such virus. In particular the invention relates to such a device in the form of a face mask. The invention also relates to novel filter materials suitable for use in such a device.

In the past century three pandemics of Influenza have been witnessed, of which the “Spanish flu” of 1918 was the largest pandemic of any infectious disease known to medical science (Oxford, J. S., 2000). The three strains which caused these pandemics belong to group A of the influenza virus and, unlike the other two groups (B and C), this group infects a vast variety of animals (poultry, swine, horses, humans and other mammals). Influenza A virus continue to cause global problems, both economically and medically (Hayden, F. G. & Palese, P., 2000). The current global concern is the avian Influenza A H5N1 virus, which first demonstrated its ability to infect birds in China in 1997 and has since spread to other countries in South East Asia, Europe and Africa (Enserink, M, 2006: Guan, Y. et al., 2004; Peiris, J. S. et al., 2004). Its ability to cause severe disease in birds was documented by the World Health Organisation during a mild outbreak in South East Asian birds during 2003-2004. H5N1 mutates rapidly and is highly pathogenic. Its co-existence with other avian influenza virus increases the likelihood of concurrent infections in birds. Such events would provide the ‘mixing vessel’ for the emergence of a novel subtype with sufficient avian genes to be easily transmitted between avian species, which would mark the start of an influenza epidemic (WHO Fact sheet).

Much has been done to control and prevent another pandemic from occurring with many anti-influenza products (vaccines and treatments) currently on the market. Presently, Amantadine is the principal antiviral compound against Influenza infections, but its activity is restricted to Influenza A virus. Anti-neuraminidase inhibitors, such as Zanamivir (Relenza) and Oseltamivir (Tamiflu), are a new class of antiviral agents licensed for use in the treatment of both Influenza A and B infections (Carr, J., et al., 2002). The role of these antivirals in a pandemic may be limited due to the time and cost involved in production and the current limited supply. With the recent news of a probable H5N1 pandemic the need to prevent any opportunities of transmission of the virus between avian species has risen.

The inhalation of air contaminated by harmful virus and/or other micro-organisms is a common route for infection of human beings, particularly health workers and others caused to work with infected humans or animals. Air exhaled by infected patients is a source of contamination. At the present time the risk of infection by the so called “bird flu” H5N1 virus is of particular concern. Masks incorporating a suitable filter material would be ideal for use as a barrier to prevent species-to-species transmission of the virus.

Air filters believed to remove such virus and/or other micro-organisms are known. One type of such a filter comprises a fibrous or particulate substrate on which is deposited, upon the surface and/or into the bulk of such fibres or particles, a substance which captures and/or neutralizes virus and/or other micro-organisms of concern. Examples of disclosures of such filters are listed below.

U.S. Pat. No. 3,871,950 and U.S. Pat. No. 4,181,694 disclose hollow fibres of acrylonitrile polymers for ultrafilter use, primarily for filtering aqueous media. U.S. Pat. No. 4,856,509 discloses a face mask wherein select portions of the mask contain a viral destroying agent such as citric acid. U.S. Pat. No. 5,767,167 discloses aerogel foams suited for filtering media for capture of micro organisms such as virus etc. U.S. Pat. No. 5,783,502 discloses a fabric substrate with anti viral molecules, particularly cationic groups such as quaternary ammonium cationic hydrocarbon groups bonded to the fabric. U.S. Pat. No. 5,851,395 discloses a virus filter comprising a filter material onto which is deposited a virus-capturing material based on sialic acid (9-carbon monosaccharides having a carboxylic acid substituent on the ring). U.S. Pat. No. 6,182,659 discloses a virus-removing filter based on a Streptococcus agalactiae culture product. U.S. Pat. No. 6,190,437 discloses an air filter for removing virus from the air comprising a carrier substrate impregnated with “iodine resins”. U.S. Pat. No. 6,379,794 discloses filters based on glass and other high modulus fibres impregnated with an acrylic latex. U.S. Pat. No. 6,551,608 discloses a porous thermoplastic material substrate and an antiviral substance made by sintering at least one antiviral agent with the thermoplastic substance. U.S. Pat. No. 7,029,516 discloses a filter system for removing particles from a fluid comprising a non-woven polypropylene base upon which is deposited an acidic polymer such as polyacrylic acid. US-A-2004/0250683 discloses a filter material comprising a network of fibres with an acidic substance deposited thereon, which may be an acrylic polymer. US-A-2005/0247608 discloses a filter block which may be treated with various anti viral polymers, principally cationic polymers.

WO-A-2001/07090 discloses a filter for removing micro-organisms comprising a substrate having a reactive surface and a polymer on its surface which includes cationic groups for attracting micro organisms. WO-A-2002/058812 discloses an air filter with micro-encapsulated biocides. WO-A-2003/039713 discloses a filter material said to have an anti pathogenic effect, including an effect against virus, based on a fibrous substrate partly coated with a polymer network containing pendant functional groups which may be acidic groups. WO-A-2005/070242 discloses an inhalation filter made of fibres treated to impart an electrical charge to catch particles such as virus.

GB-A-2035133 discloses a membrane filter with a water-insoluble polymer, preferably a PVA, on its surface. Use of such a filter material in gas mask cartridges is suggested.

JP-A-2001/162116 discloses an antibacterial filtration medium in which a self-cross-linking acrylic resin is used to bind a silver-organic idine antibacterial agent to a fibrous substrate. JP-A-2005/198676 discloses the use of a water-hardenable resin emulsion to bind citric acid to an antiviral face mask.

Three papers in Journal of Virology: September 1968, p 878-885; March 1970, p 313-320 and p 321-328, disclose antiviral activity of various polycarboxylic acids including polyacrylic acid, polymethacrylic acid and polyacetal carboxylic acids. The antiviral activity reported therein appears to be a cell-mediated effect, and the conclusion is expressed that “PMAA (polymethacrylic acid) did not inactivate the virus particle in its extracellular state”.

There is an ongoing need to improve such filters, particularly in view of perception of risks from “bird flu”. The present inventors have identified filter materials which may facilitate an increased level of removal of harmful virus and/or other micro-organisms from inhaled air and neutralisation of the same, enabling the use of such materials in an improved nasal and/or mouth filter.

According to a first aspect of this invention there is provided an air-permeable mask of a shape suitable to be placed over a user's mouth and nose and to sealingly contact the user's face, provided with means to hold the mask in place on the user's face, and comprising one or more layer of a filter material positioned such that inhaled and/or exhaled air of the user passes through the filter material, wherein the filter material comprises an air permeable substrate combined with an acidic polymer.

The overall shape of the face mask may be generally conventional in the field of face masks, and the means to hold the mask in place on the user's face may for example comprise one or more elastic strap to be passed behind the user's head.

The air-permeable substrate may comprise a fibrous substrate, which can either be a woven or non-woven material. Examples of woven materials include those natural and synthetic fibers such as cotton, cellulose, wool, polyolefins, polyester, polyamide (e.g. nylon), rayon, polyacrylonitrile, cellulose acetate, polystyrene, polyvinyls and any other synthetic polymers that can be processed into fibers. Examples of non-woven materials include polypropylene, polyethylene, polyester, nylon, PET and PLA. For this invention, non-woven is preferred. Such a material may be in the form of a non-woven sheet or pad.

Non woven polyester is a preferred air-permeable substrate because it is found that the acidic polymers of the types described herein adhere better to polyester material. There appears to be less tendency for the acidic polymers to visibly flake or rub off a polyester substrate. Polyester fibres and fabrics made therefrom are well known. The term “polyester” as used herein is a generic name for a manufactured fibre being a polymer with units linked by ester groups. A common polyester used for woven and non-woven fibre manufacture is polyethylene terephthalate, comprising:

—[—O.CO—C₆H₄—CO.O—CH₂—CH₂—]ₙ—

units.

The grade of fibrous substrate which may be used may be determined by practice to achieve a suitable through-flow of air, and the density may be as known from the face-mask art to provide a mask of a comfortable weight.

Non-woven polypropylene of the type conventionally used for surgical masks and the like is widely available in sheet form. Suitable grades of non-woven polypropylene include the well known grades commonly used for surgical face masks and the like. Typical non-woven polypropylene materials found suitable for use in this invention have weights 10-40 g/m², although other suitable material weights can be determined empirically.

Typical non-woven polyester materials found suitable for use in this invention have weights 10-200 g/m², although materials toward the upper end of this range may be rather heavy for use in a face mask. For example materials of weight 20-100 g/m² are preferred, e.g. ca. 60 g/m². Such materials are commercially available. Other suitable materials can be determined empirically.

Alternatively the substrate may be in other forms such as an open-cell foam, e.g. a polyurethane foam as is also used for air filters, for example as in nasal air plugs.

It has been found that acidic polymers are effective at capturing and neutralising virus in air passing through such a material. Without being limited to a specific theory of action it is believed that upon contact with the surface of the substrate the virus interact with the polymer, are entrapped and the localised low pH environment (e.g. ca. pH 2.8 to 5) of the acidic polymer inactivates the virus to thereby neutralise them. It is believed that the filter material of this invention may be effective in this manner against the virus that cause colds, influenza, SARS, RSV, bird flu and mutated serotypes of these.

As used herein the term “acidic polymer” includes a polymer having acidic groups along its backbone, e.g. as side groups. Suitable acidic groups are carboxylic acid groups. The acidic polymer may be cross-linked or linear. Generally for the present application non-cross linked, e.g. linear polymers are preferred. This is inter alia because relative to cross-linked polymers non-cross linked linear structure can provide more available —COOH groups, and also non-cross linked polymers are easier to dissolve and consequently to use in the preparative process disclosed herein.

The acidic polymer may comprise a poly-(carboxylic acid) polymer.

Poly-(carboxylic acid) polymers are typically polymers which include —COOH groups in their structure, or derivative groups such as acid-anhydride groups, readily cleavable carboxylic acid ester groups or salified —COOH groups which readily cleave to yield —COOH groups.

A poly-(carboxylic acid) polymer may have its —COOH groups (or derivative groups) directly linked to its backbone, or the polymer may be a so-called grafted or dendritic polymers in which the —COOH (or derivative) groups are attached to side chains branching off from the backbone.

For example poly-(carboxylic acid) polymers may include:

—[—CR¹.COOH—]—

units in their structure, wherein R¹ is preferably hydrogen, or R¹ may be C₁₋₃ alkyl, C₁₋₃ alkoxy or C₁₋₃ hydroxy alkyl.

One type of such a poly-(carboxylic acid) polymer comprises a polymer having units:

—[—CR²R³—CR¹.COOH—]—

in its structure wherein R² and R³ are independently preferably hydrogen, or may be C₁₋₃ alkyl or C₁₋₃ alkoxy. For example such a polymer may comprise a poly-(carboxyvinyl) polymer, for example a polymer of a monomer compound of formula CR²R³═CR¹.COOH wherein the substituents are as defined above. Such a polymer may comprise a polymer of acrylic acid or methacrylic acid, i.e. polyacrylic or polymethacrylic acid, e.g. linear polyacrylic and polymethacrylic acid homo- and co-polymers. An example of such a polymer is carboxypolymethylene. An example of a commercially available polyacrylic acid is the material Good-Rite™ K-702 which has a molecular weight of around 30,000. An example of a commercially available polyacrylic acid, as its sodium salt, is the material Good-Rite™ K-765 which also has a molecular weight of around 30,000. Polyacrylic acid polymers are commercially available under the trade name Carbomer™ classified as a synthetic polymer and is otherwise used as an emulsion stabilizer as well as an aqueous viscosity-increasing agent.

Polymers of this type are for example disclosed in U.S. Pat. No. 2,798,053 viz “a carboxylic monomer such as acrylic acid, maleic acid or anhydride and the like, copolymerized with certain proportions of a polyalkenyl polyether of a polyhydric alcohol containing more than one alkenyl ether grouping per molecule, the parent polyhydric alcohol containing at least 4 carbon atoms and at least three hydroxyl groups.”

Examples of cross-linked poly-(carboxylic acid) polymers include homopolymers of acrylic acid crosslinked with an allyl ether, e.g. of pentaerythritol, of sucrose or of propylene, e.g. the material available from B.F. Goodrich Company under the trade name “Carbopol”, such as the specific Carbopols include Carbopol 934, 940, 980, 1382, Carbopol ETD 2020, ETD 2050, Ultrez 20 and 21.

Another type of such a poly-(carboxylic acid) polymer may include adjacent

—[—CR¹.COOH—]—

units (where R¹ is defined above) in its structure, for example polymers based on maleic acid moieties which typically include —[—CH.COOH—CH.COOH—]— units, and/or salts or esters of such units, or such units in anhydride form in which COOH groups on adjacent carbon atoms may be cyclised to form a —CH.CO—O—CO.CH— ring system, such derivatives being susceptible to hydrolysis to form the corresponding free acid.

One type of such a poly-(carboxylic acid) polymer may comprise units with pairs of carboxylic acid groups on adjacent polymer chain carbon atoms. For example such polymers may comprise units:

—[—CR¹R²—CR³R⁴—CR⁵.COOH—CR⁶.COOH—]—

in its structure wherein R¹, R², R³, R⁴, R⁵ and R⁶ are independently hydrogen (preferred) or C₁₋₃ alkyl or C₁₋₃ alkoxy, preferably R¹ and R² being hydrogen, R³ being hydrogen R⁴ being methoxy, and R⁵ and R⁶ being hydrogen, or a derivative thereof retaining COOH groups in its structure, or groups readily hydrolysable to COOH groups. Such a poly-(carboxylic acid) polymer is the polymer based on a copolymer of methyl vinyl ether and maleic anhydride. Such polymers are commercially available under the trade name Gantrez™.

An example of such a polymer comprises:

—[—CH₂—CH.OCH₃—CH.COOH—CH.COOH—]—

units in its structure.

Such polymers may be linear polymers, or cross linked polymers. Linear, non-cross linked, polymers of this type are commercially available under the trade name Gantrez™ S (CAS # 25153-4-69), e.g. Gantrez™ S-96 having a molecular weight ca.700,000, Gantrez™ S-97 having a molecular weight ca. 1,200,000. Such Gantrez polymers are preferred. In experiments it was found that that a filter material comprising such a Gantrez polymer retained its surface pH of below pH 3.5, suitable to kill viruses, even after 24 hours of immersion in water.

Cross linked polymers of this type are also commercially available under the Gantrez™ trade name.

An example of a derivative of such an acid is an anhydride, i.e. in which the two adjacent —COOH groups are cyclised to form a —CH.CO—O—CO.CH— ring system, such an anhydride is susceptible to hydrolysis to form the corresponding free acids. Such polymers are commercially available under the trade name Gantrez™ AN (CAS # 9011-16-9), e.g. Gantrez™ AN-119, Gantrez™ AN-903, Gantrez™ AN-139, Gantrez™ AN-169.

Another example of a derivative is a partial salt, e.g. where some of the free —COOH groups are converted into a metal salt of a Group I or Group II metal such as respectively either sodium or calcium, or a mixed sodium-calcium salt. Such a polymer is commercially available under the trade name Gantrez™ MS, e.g. Gantrez™ MS-955 (CAS # 62386-95-2).

Another example of a derivative of such an acid is a partial ester in which some of the free —COOH groups are esterified with C₁₋₆ alkyl e.g. ethyl or n-butyl. Such polymers are commercially available under the trade name Gantrez™ ES, e.g. Gantrez™ ES-225 (CAS # 25087-06-03) or Gantrez™ ES-425 (CAS # 25119-68-0. Typically polymers of this second type have molecular weights in the range 200,000-2,000,000.

Other poly-(carboxylic acid) polymers of this type include copolymers of C₁₀₋₃₀ alkyl acrylates and one or more monomer compound of formula R⁴R⁵C═CR⁶—COO R⁷, wherein each of R⁴, R⁵, R⁶, and R⁷ is independently selected from hydrogen or C₁₋₅ alkyl, in particular methyl, ethyl or propyl. Examples of such monomer compounds include esters of acrylic acid and methacrylic acid.

Other suitable poly-(carboxylic acid) polymers include anionic polymers based on compounds of formula R₁R₂C═CR₃—COO R₄, wherein each of R₁, R₂, R₃ and R₄ is independently selected from hydrogen or C₁₋₅ alkyl, in particular methyl, ethyl or propyl. Examples of such polymers are those based on methacrylic acid and ethylacrylates with carboxylic acid functional groups available from Rohm GmbH & Co under the trade name “Eudragit”. Specific grades include Eudragit L100-55, L30-D-55, L100, S100 and FS 30D.

Other suitable acidic polymers may be polymers incorporating other acid groups such as sulphonic acid groups. Example of acidic polymers incorporating sulphonic acid groups are co-polymers of an acrylic or methacrylic acid with a sulphonic acid, e.g. linear copolymers. Such polymers incorporating sulphonic acid groups may be used in the form of their salts, e.g. their sodium salts. An example of a copolymer of acrylic acid and sulphonic acid is commercially available under the trade name Good-Rite™ K-776. Other acidic polymers may comprise copolymers of acrylic acid and a sulphonic acid. For example the acidic polymer may comprise copolymers and terpolymers of maleic acid, poly(2-acrylamido-2-methylpropane sulfonic acid) (“polyAMPS”), and copolymers of acrylic acid and 2-acrylamido-2-methylpropane sulfonic acid.

Polystyrene sulphonic acids may be suitable, for example a commercially available plystyrene sulphonic acid in the form of its sodium salt available under the name Flexan™ II with a molecular weight of around 120,000 may be suitable.

Other suitable acidic polymers are believed to include polyvinyl phosphonic acids.

Acidic polymers which have been found useful for the purposes herein have been found to have molecular weights in the range 30,000 to 2,000,000 but molecular weight does not appear to be critical, and this may be simply an exemplary range.

Additional substances may be incorporated into the filter material, for example additional substances to optimize the properties and anti-viral effectiveness of the filter material.

For example the acidic polymer may be used in combination with a plasticiser material to encourage the formation of a film of the acidic polymer on the fibres of the substrate material. In particular a plasticiser material may be useful in combination with the anionic polymers based on compounds of formula R₁R₂C═CR₃—COO R₄, mentioned above, such as the above-mentioned “Eudragit” polymers. Suitable plasticisers include triethyl citrate, and diethyl or dibutyl phthalate. A proportion of plasticizer, if used, of ca. 1 to 20 wt. % of the weight of the acidic polymer appears to be suitable.

For example the filter material may incorporate one or more organic carboxylic acid, preferably a solid such acid. Examples of such solid carboxylic acids include: salicylic, fumaric, benzoic, glutaric, lactic, citric (which is preferred), malonic, acetic, glycolic, malic, adipic, succinic, aspartic, phthalic, tartaric, glutamic, pyroglutamic, gluconic acid, and mixtures of two or more thereof.

It is known e.g. from the state of the art reviewed above to use acids such as citric acid as antiviral agents, and the presence of such an acid can enhance the anti-viral activity of the filter material. However it has hithertoo been found difficult to deposit citric acid on filter substrate materials such as the above-mentioned e.g. polypropylene or polyester because of poor adhesion between the citric acid and the substrate. It has advantageously been found that acidic polymers of the type used in the present invention can act to enhance binding of such acids to such substrates.

Typically the weight ratio of acidic polymer:organic acid in the filter material may be in the range 10:1 to 1:1, preferably 3:1 to 1:1, for example 2+/−0.25:1.

For example the filter material may incorporate one or more surfactant. A surfactant can facilitate wetting of the filter material. Airborne pathogens such as virus are known to be carried in small droplets of water, and consequently enhanced wetting of the filter material can enhance the effective contact between the pathogen and the active materials on the filter material. Furthermore surfactants are known to be effective in disrupting the membranes of virus and bacteria. Non-ionic surfactants are preferred because ionic surfactants can tend to cause the acidic polymer to gel. A preferred non-ionic surfactant is selected from the Tween™ or Polysorbate™ family of surfactants.

Typically the weight ratio of acidic polymer:surfactant in the filter material may be in the range 10:1 to 1:1, preferably 3:1 to 1:1, for example 2+/−0.25:1.

Although in general a high loading of the acidic polymer on the substrate is desirable to achieve high effectiveness against pathogens, it is found that this should be balanced against the disadvantage that too high a loading can result in blockage of the passage of air through the filter material.

To achieve a suitable amount of inactivation of viruses in air passing through the face mask, combined with permeability of a suitable rate of inhaled or exhaled air, the total loading of the acidic polymer plus any carboxylic acid if present and plus any surfactant if any on the substrate of the filter material is preferably in in the range 20-50 g/m², particularly 25-45 g/m². For substrates of the typical weights per square metre discussed herein this can correspond to total loading of the acidic polymer plus any carboxylic acid if present and plus any surfactant if any on the substrate of the filter material, (based on the substrate itself of a starting 100% weight) of 5-60 wt %, typically 10-30 wt %.

For example the filter material may incorporate one or more metal salt, for example selected from salts of silver, zinc, iron, copper, tin and mixtures thereof. Such salts may have antibacterial activity. These may be inorganic salts such as those of mineral acids such as chloride, nitrate or sulphate, or organic salts. An example of a metal salt of this type is zinc chloride.

For example the filter material may incorporate one or more antimicrobial compound. Suitable examples of such compounds include quaternary ammonium compounds (e.g. benzalkonium chloride, cetrimide), phenolic compounds (e.g. triclosan, benzoic acid) biguanides (e.g. chlorhexidine, alexidine) and mixtures thereof.

An overall preferred filter material comprises a linear acid polymer which comprises:

—[—CH₂—CH.OCH₃—CH.COOH—CH.COOH—]—

units in its structure, in particular Gantrez™ S-97, together with citric acid and a non-ionic surfactant, particularly Tween 20 or Polysorbate 20, deposited on a non-woven polyester fibrous substrate, in the proportions described herein.

Certain acidic polymers may benefit from the presence of a stabilizer of known type. For example Gantrez™ polymers may benefit from the presence of EDTA disodium salt as a stabilizer.

Certain filter materials disclosed herein for use in the face mask of this invention are believed to be novel per se.

Therefore in a further aspect the present invention provides a filter material suitable for use in the face mask of this invention.

Preferred types, features and embodiments of such a filter material are as discussed above.

One particular type of such a filter material comprises a fibrous substrate (as discussed above) on which is deposited an acidic polymer which is a linear acidic polymer.

Another particular type of such a filter material comprises a fibrous substrate (as discussed above) on which is deposited an acidic polymer which comprises a poly-(carboxylic acid) polymer which includes adjacent

—[—CR¹.COOH—]—

units (where R¹ is defined above) in its structure. Specific types of these are for example the polymers based on maleic acid moieties which typically include —[—CH.COOH—CH.COOH—]— units, and/or salts or esters of such units, or such units in anhydride form in which COOH groups on adjacent carbon atoms may be cyclised to form a —CH.CO—O—CO.CH— ring system, such derivatives being susceptible to hydrolysis to form the corresponding free acid.

Another particular type of such a filter material comprises a fibrous substrate (as discussed above) on which is deposited an acidic polymer in combination with an organic carboxylic acid.

A particularly preferred filter material of this aspect of the invention comprises the above mentioned non-woven polypropylene or particularly polyester fibrous substrate with the linear acid polymer which comprises:

—[—CH₂—CH.OCH₃—CH.COOH—CH.COOH—]—

units in its structure, in particular Gantrez™ S-97, deposited on its surface, together with citric acid and a non-ionic surfactant, particularly Tween 20 or Polysorbate 20.

In this filter material, for the reasons explained above, the total loading of the acidic polymer plus any carboxylic acid if present and plus any surfactant if any on the substrate of the filter material is preferably in in the range 20-50 g/m², particularly 25-45 g/m².

Such filter materials may have independent utility, e.g. in other types of air filter system.

The filter material described herein may be made in various ways, in which the air-permeable substrate is combined with the acidic polymer.

In one way the acidic polymer may be deposited on the air-permeable substrate as a complete or partial film on the substrate material, e.g. on fibres thereof.

In another way the acidic polymer may be incorporated into the material of the air-permeable substrate, e.g. into fibres thereof. This may be done during the fibre-forming process, e.g. spun bond and melt blown to form non-woven materials.

In another way filter materials of the present invention may be made by known electrospinning processes, in which an electrified liquid jet of a polymer, in the form of a solution or melt is formed, and is deposited on a grounded collector fibre.

In a preferred manufacturing process to make a filter material of the invention, e.g. for a face mask of this invention, the acidic polymer may be incorporated in a liquid vehicle, the substrate material may then be wetted with the resulting liquid composition, and the liquid vehicle allowed or caused to evaporate to thereby leave the acidic polymer deposited on the substrate.

Such a resulting liquid composition is herein termed a “loading solution”.

The liquid vehicle may be aqueous, e.g. water or a mixture of water and an alcohol (e.g. methanol, ethanol, propanol). The acidic polymer, may be dissolved or suspended in the liquid vehicle. The loading solution may incorporate any additional substances such as the above-mentioned solid carboxylic acid, surfactant, metal salt, antimicrobial compound, stabiliser etc. e.g. dissolved or suspended, in the liquid vehicle. This loading solution may also be adjusted to a suitable pH if necessary, for example pH 2-3, typically ca. 2.5. For example an alkali such as sodium hydroxide, or a buffer such as a citrate e.g. sodium citrate, may be included into the loading solution to achieve such a pH.

Wetting of the substrate may be achieved by simply coating the substrate material with the so-formed dispersion, e.g. dipping the substrate into the loading solution. Alternatively the substrate material may be sprayed with the loading solution. On an industrial scale spraying is preferred for convenience. The wetted substrate may then be dried, e.g. by evaporation in the ambient air or in a drying tunnel. A suitable drying temperature in such a tunnel is less than 100° C.

A loading solution suitable for use in the process for making the filter material is a further aspect of this invention.

For example such a loading solution may be made in the liquid vehicle comprising 0.5-10 wt %, typically 1-5 wt % of the acidic polymer such as Gantrez S-97; 0-4.0 wt % organic carboxylic acid, e.g. 1-2 wt % citric acid; and 0-4.0 wt % surfactant, e.g. 1-2 wt % surfactant, e.g. Polysorbate or Tween 20.

Loading solutions containing Gantrez acids such as Gantrez S-97 may benefit from the presence of a stabilizer in the loading solution for the Gantrez acid. A suitable stabilizer is EDTA disodium salt at 100 ppm.

Accordingly the filter material may be a product obtainable or obtained by the process of wetting the air-permeable substrate with the loading solution, and causing or allowing the liquid vehicle to evaporate therefrom so as to deposit substances in the loading solution onto the substrate.

WO-A-03/039713 discloses a method of forming its coatings of acidic polymers on fibrous substrates by polymerization of monomers on the fibre surface. The above-mentioned method in which the already-formed polymer is deposited from solution or suspension onto the fibrous substrate is preferred because the method of WO-A-93/039713 can leave traces of undesirable monomer on the surface of the fibres.

An advantage of the filter materials of the present invention is that their antiviral activity can be such that an oral and/or nasal filter can be made in a lightweight form. Furthermore filter materials of the invention may be rapidly effective against pathogens such as the virus mentioned herein.

Typically the filter material may be in sheet or pad form, generally corresponding to the shape of a starting sheet or pad of the fibrous substrate, suitable for use in the above-mentioned face mask. Such sheet or pad form materials can be made into a suitable shape for a face mask of generally known shape in a known manner.

Face masks can be made from such materials using known mask-making processes, e.g. moulding/folding. Accordingly in a further aspect of this invention a process for making a face mask is provided comprising providing a filter material as described herein and forming the filter material into a face mask.

A face mask of this invention may comprise one, two, three or more layers of such a sheet or pad form filter material. The filter material of the invention in sheet form can be adapted easily to the convex shape appropriate for fitting to a user's face. The face mask may additionally comprise one or more layer of a further material, e.g. one layer backing the filter material, or two layers sandwiching the filter material, optionally with one or more further layer. Such a further layer of material may be situated in the face mask such that when the mask is used the layer of further material is positioned between the filter material and the user's skin to thereby reduce any irritation to the user's skin.

Such further material may be woven or non-woven material. Examples of woven materials include those natural and synthetic fibers such as cotton, cellulose, wool, polyolefins, polyesters, nylon, rayon, polyacrylonitrile, cellulose acetate, polystyrene, polyvinyls and any other synthetic polymers that can be processed into fibers. Examples of non-woven materials include polypropylene, polyethylene, polyester, nylon, PET and PLA. For this invention, non-woven is preferred. Such a material may be in the form of a non-woven sheet or pad. Suitable grades of non-woven polypropylene include the well known grades commonly used for surgical face masks and the like. Alternatively the substrate may be in the form of an open-cell foam, e.g. a polyurethane foam as is also used for air filters, for example in nasal air plugs.

A suitable material for this further material is polyester, cellulose or non-woven polypropylene of the type conventionally used for surgical masks and the like.

For example a face mask of the invention may comprise a filter material comprising a polyester material having an acidic polymer deposited thereon, and a further layer of a non-woven polypropylene material positioned to be between the filter material and the user's skin. A layer of the filter material and a layer of the further material may for example be welded together, e.g. around their respective edges, e.g. by ultrasonic welding.

Generally face masks of this invention should meet the standards Fluid Resistance ASTM F 1862, Filtration Efficiency—N95 Respirators or Particulate Filtration (ASTM F 1215-89) and Bacterial Filtration (ASTM F2101-01), Differential Pressure (Delta-P) Test, Flammability to meet 16CFR 1610, NFPA and CPSC standards.

Typically a face mask of this invention has a filtering area of 185 cm²+/−20%. For defined flows the initial pressure drop of the mask should meet the following specifications:

| Flow (Litres/minute) | Pressure drop (mm of water column) |
|---|---|
| 30 | 0.5 |
| 85 | 1.0 |
| 95 | 1.0 |
| 160 | 2.0 |

The filter materials of this invention may be used in other types of breathing air filter such as nose plugs. Such a filter may be of generally conventional form, incorporating the filter material of the invention.

Therefore in a further aspect the present invention provides a method of removing airborne pathogens, particularly virus, e.g. influenza virus such as H5N1 virus, from air, comprising passing air believed to be contaminated with such virus through a face mask, or through one or more layer of a filter material of this invention, particularly a layer of the filter material comprising a part of a face mask.

The present invention will now be described by way of example only with reference to the accompanying drawings.

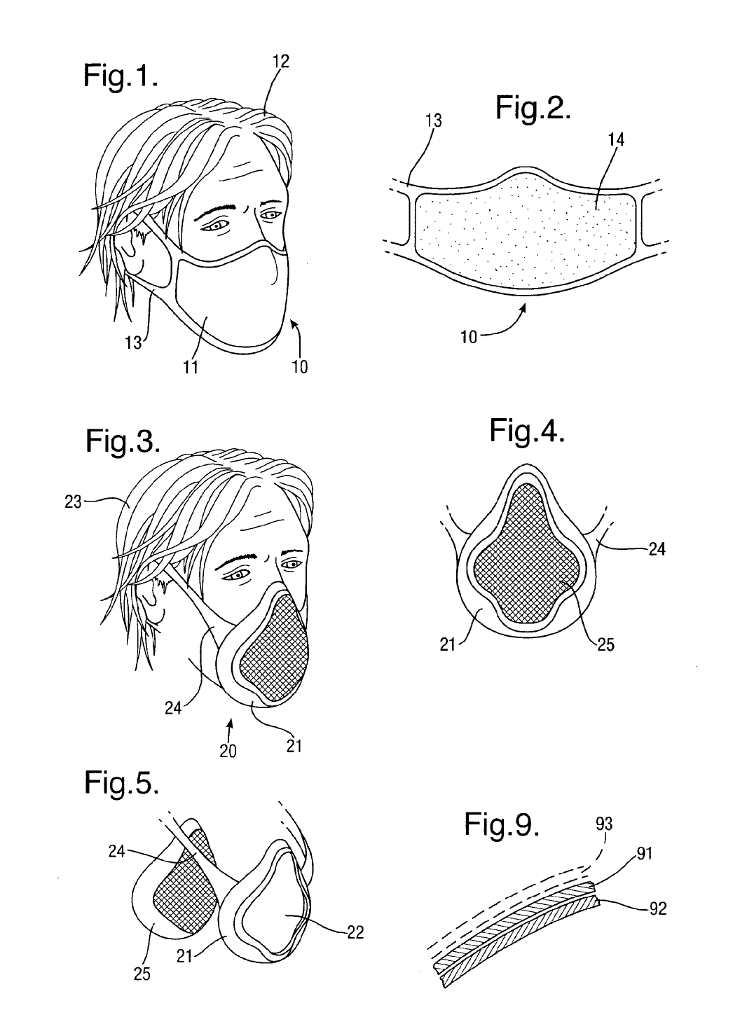

FIG. 1 shows a perspective view of a oral and nasal filter in use.

FIG. 2 shows the filter of FIG. 2 unattached to the user.

FIG. 3 shows a perspective view of an alternative construction of oral and nasal filter in use.

FIG. 4 shows a front view of the filter of FIG. 3

FIG. 5 shows a dissembled view of the filter of FIG. 3

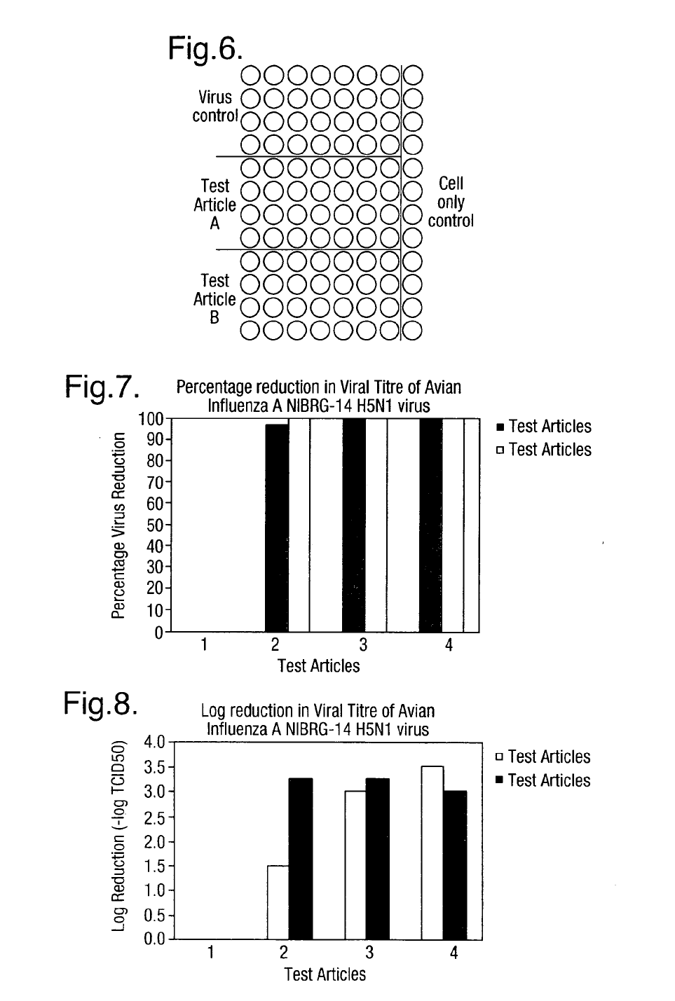

FIG. 6 shows a typical 96-well plate layout.

FIG. 7 shows graphically the percentage reduction in viral titre.

FIG. 8 shows graphically the log reduction in viral titre.

FIG. 9 shows a section through the material of the face mask of FIGS. 1-5.

Referring to FIGS. 1 and 2, an oral and/or nasal filter for inhaled or exhaled air comprising such a filter material of this invention is shown. The filter 10 (overall) is of generally conventional construction comprising a pad (11) which may be attached over the nose and mouth of a user (12) by a conventional strap (13). The pad (11) comprises an outer layer (14) of the filter material of the invention stitched to an inner polyester fibre pad (not visible), the outer layer (14) being in a position to intercept a stream of inhaled or exhaled breathing air.

Referring to FIGS. 3, 4 and 5, an alternative oral and/or nasal filter for inhaled or exhaled air comprising such a filter material of this invention is shown. The filter 20 (overall) is of generally conventional construction comprising a flexible moulded outer structure (21) with an aperture (22) and which may be attached to the face of a user (23) by a conventional strap (24). The filter material is provided as a pad (25) comprising an outer layer of the filter material of the invention and an inner layer of the polyester fibre, and the combined moulded layers of the filter material and polyester fibre are pressed into the aperture (22) in a position to intercept a stream of inhaled or exhaled breathing air passing through the aperture (22).

Referring to FIG. 9, this shows a suitable layered construction of the mask of FIGS. 1-5. There is a layer 91 of the filter material, an inner layer 92 of a non-woven polypropylene material which in use is against the user's skin, and an optional outer layer 93, also of a non-woven polypropylene material. There may be plural layers 91, 92, 93.

Materials suitable as the filter material of the invention may be prepared by first preparing a loading solution comprising the acidic polymer and any additional substances, wetting the air-permeable substrate material with this solution, then allowing or causing the solvent vehicle of the loading solution to evaporate to leave the polymer and substances originally dissolved or dispersed in the vehicle deposited onto the substrate.

Examples of loading solutions are given below:

### EXAMPLE 1

| | |
|---|---|
| Acidic polymer: | Carbopol ETD 2020 2% w/w |
| Organic carboxylic acid: | Citric Acid 1% w/w |
| | Water to 100% |

### EXAMPLE 2

| | |
|---|---|
| Acidic polymer: | Carbopol ETD 2020 1% w/w |
| Organic carboxylic acid: | Citric Acid 1% w/w |
| | Water to 100% |

### EXAMPLE 3

| | |
|---|---|
| Acidic polymer: | Carbopol ETD 2020 2% w/w |
| | Water to 100% |

### EXAMPLE 4

| | |
|---|---|
| Acidic polymer: | Carbopol 980 1.5% w/w |
| Organic carboxylic acid: | Citric Acid 1% w/w |
| Metal salt: | Zinc Chloride 0.5% |
| | Water to 100% |

### EXAMPLE 5

| | |
|---|---|
| Acidic polymer: | Eudragit L50 D55 10% w/w |
| Organic carboxylic acid: | Tartaric Acid 0.5% |
| Plasticiser: | Triethyl Citrate 1.0 w/w |
| | Water to 100% |

### EXAMPLE 6

| | |
|---|---|
| Acidic polymer: | Carbopol ETD 2020 1.5% w/w |
| Organic carboxylic acid: | Citric Acid 0.5% w/w |
| Antimicrobial compound: | Triclosan 0.2% w/w |
| | Water to 100% |

Respective samples of a non-woven polypropylene of a conventional type as used for surgical masks were coated with each of these solutions, the sample was allowed to drain off excess liquid, and then allowed to air dry. This procedure using the above solutions resulted in a ca. 10% w/w deposition of the acidic polymer onto the substrate material.

### In Vitro Test Data.

A study was performed to investigate the in-vitro efficacy of 5 mask materials against avian NIBRG-14 Influenza H5N1 virus. The mask materials were coated using loading solutions containing Carbopol ETD 2020 (abbreviated herein “ETD”) at 0, 1 or 2%, and citric acid (at 0, 0.5 or 1%). Treating the virus for 60 minutes with the coated mask materials from the 2% ETD and 0.5 or 1% citric acid loading solution was observed to reduce viral titres in comparison with non-coated mask materials. Reduction in viral titres between 96.8 and 99.9% was observed in this study. The study described was conducted in compliance with The United Kingdom Good Laboratory Practice Regulations 1999 Statutory Instrument No. 3106; The United Kingdom Good Laboratory Practice (Codification Amendments etc.) Regulations 2004 Statutory Instrument No. 994; and OECD Principles of Good Laboratory Practice, (Revised 1997).

### ABBREVIATIONS

### CDC Centre for Disease Control

### HA Haemagglutinin

HA assay Haemagglutination assay
MDCK cells Madin-Darby canine kidney cells
PBS Phosphate-buffered saline
PPE Personal protective equipment
vCPE Viral cytopathic effect
(v/v) Volume per volume

### Materials and Methods.

The mask substrate material was made up of polypropylene (70-100%) reference Vilmed VS, 3440 supplied by Freudenberg. 4 mask materials and 1 control material were used as respective Test and Control Articles being the mask substrate material treated with loading solutions as follows:

Test Article 1: coated with 1% ETD 2020 loading solution.
Test Article 2: coated with 1% ETD 2020+0.5% Citric acid loading solution.
Test Article 3: coated with 2% ETD 2020 loading solution.
Test Article 4: coated with 2% ETD 2020+1% Citric acid loading solution.
Control Article: uncoated mask material loading solution.

Citric acid was supplied by VWR Ltd. catalogue number: 100242 ID number: 1008100.

CARBOPOL ETD 2020 was supplied by Noveon Inc. catalogue number: CBPETD2020.

### Control Reference Articles.

The controls utilised in the virucidal assay are:

Cell only control: cells not infected with virus. This was a negative control for vCPE (viral cytopathic effect) and is also an indicator of cell quality.
Virus only control: cells infected with virus at 1/10 (v/v) dilution in standard infection media. This was a positive control for vCPE.
Antiviral control: cells infected with virus pre-treated with citrate buffer at pH3.5. This was a positive control for comparison with the test articles.

The cells of the virucidal controls were incubated with newly made-up cell infection media.

### Cells and Virus

The cells used in this study were MDCK cells and were supplied from Retroscreen Virology Ltd's cell bank.

The virus used in this study was avian NIBRG-14 Influenza H5N1 virus and was supplied from the Retroscreen Virology Ltd's virus repository, aliquot number 800. The titre of diluted avian NIBRG-14 Influenza H5N1 virus was 4.72-log 10 TCID50/ml (as determined by the mean value of the control virus titres obtained from the virucidal assay).

Before use in the virucidal assay, the stock virus was diluted 1/10 (v/v) in distilled water.

### Procedure

### Preparation of MDCK Cells

MDCK cells (100 μl/well) were seeded onto 96-well plates at a density of ˜5×104 cells/ml. The cells were incubated at 37° C. and 5% CO₂ for ˜24 hours. The plates were washed twice with PBS (100 μl/well) and Standard infection media (100 μl/well) added before use in either the virucidal assays.

### Virucidal Assay

A summary of the procedure for the virucidal assay is listed below.

1) Reaction: Virus was added to Test Article and left for 60 minutes.
2) Termination: The reaction was terminated with infection media and virus solution was harvested from the filters.
3) Titration: The harvested virus was titrated 10-fold on MDCK cells across a 96 well plate.
4) Incubation: Cells were incubated for 3 days.
5) Endpoint determination: vCPE observation was made and HA was performed.

A typical plate layout of a 96-well plate used in the virucidal assay and cytotoxicity assay is shown in FIG. 6.

1) Cells were made up as above.
2) 200 μl of diluted avian NIBRG-14 Influenza H5N1 virus at 1/10 (v/v) dilution in distilled water was added to each test or control article in a 6-well plate (in duplicate) and incubated at Room temperature on a shaker (at 300 MoT/minute) for 60 minutes. The reaction was stopped by addition of 1.8 ml of infection media. Virus solution was harvested into new wells in a 6-well plate.
3) In performing the procedure for the Citrate buffer control, 40 μl of virus at 1/10 (v/v) dilution in distilled water was added to 360 μl of Citrate buffer, pH 3.5 in a 7 ml bijou, the reaction was terminated after five minutes by the addition of 3.6 ml cell infection media.
4) The supernatant (111 μl) or virus only control (1/10 (v/v) dilution in infection media) was added to the first row of wells (MDCK cells in a 96-well plate). All supernatant and virus only controls were plated in quadruplicate and titrated 10-fold down the plate.
5) The plates were incubated at 37° C.+5% CO₂ for 1 hour. Then the plates were washed twice with PBS.
6) 100 μl of infection media was added to each well and plates incubated at 37° C.+5% CO₂ for 3 days
7) On day 3 post-infection, the plates were scored for vCPE and HA was performed on the supernatants in accordance with Retroscreen Virology Ltd. SOP VA018-02. An observation for agglutination was made to confirm the presence of virus.

### Karber Calculation

The log TCID50 titre was calculated using the Karber calculation, and was performed in accordance with the Retroscreen Virology Ltd. SOP VA023-02.

### Results

### Reduction in Virus Titre

The virucidal activity of each test or control article was assessed against avian Influenza

A NIBRG-14 H5N1 virus for a 60-minute contact time. The virus titre was measured by titration on MDCK cells and virus was detected by Haemagglutination assay, the results are shown in table 1 below.

The Control article was used as a control for the Test articles. Untreated virus was used as a positive control for the virucidal assay.

Results: Avian Influenza A NIBRG-14 H5N1 virus recovery, calculated log and percentage reduction following treatment with Test articles and Control article for 60 minutes are tabulated below.

| | | | | Reduction in | |
|---|---|---|---|---|---|
| Test | Test Article | Control | | viral titre (B − A) | |
| Article | (A) | Article (B) | Viral control | −log10 | |
| No. | Virus titre | Virus titer | Virus titre | TCID50/ml | % |
| 1 | 4.50 | 4.50 | 4.50 | 0.00 | 0.00 |
| 1 | 4.75 | 4.50 | 4.25 | 0* | 0* |
| 2 | 4.25 | 5.75 | 5.75 | 1.50 | 96.848 |
| 2 | 2.75 | 6.00 | 5.50 | 3.25 | 99.944 |
| 3 | 1.50 | 4.50 | 4.25 | 3.00 | 99.900 |
| 3 | 1.50 | 4.75 | 4.50 | 3.25 | 99.944 |
| 4 | 1.50 | 5.00 | 4.50 | 3.50 | 99.968 |
| 4 | 1.50 | 4.50 | 4.50 | 3.00 | 99.90 |

*Actual value is in the negative but within the variability of the assay.

The Avian Influenza A NIBRG-14 H5N1 virus recovery, calculated percentage reduction following treatment with Test articles and Control article for 60 minutes is shown graphically in FIG. 7.

The Avian Influenza A NIBRG-14 H5N1 virus recovery, calculated log reduction following treatment with Test articles and Control article for 60 minutes is shown graphically in FIG. 8.

### Conclusion.

A reduction in the viral titre of avian Influenza A NIBRG-14 H5N1 virus was observed after treatment with the test articles 2 (loading solution 1% ETD 2020+0.5% Citric acid), 3 (loading solution 2% ETD 2020), and 4 (loading solution 2% ETD 2020+1% Citric acid). No viral reduction was observed following treatment with test article 1 (loading solution 1% ETD 2020).

In this study the following mask material coating composition and combinations were compared with each other: each mask was made up of Polypropylene (70-100%) coated using loading solutions made up of ETD 2020 (0, 1 or 2%) and Citric acid (0, 0.5 or 1%).

Coated mask materials were compared with uncoated mask materials. On comparing the coated and uncoated mask materials, it was observed that coating the mask materials with loading solution 2% ETD and 0.5 or 1% Citric acid resulted in a significant reduction in viral titres (99.9%). Coating the mask material with loading solution 1% ETD and 0.5% Citric acid also resulted in a reduction in viral titre. Coating with loading solution 1% ETD did not appear to reduce the viral titres.

### Further Examples of Loading Solutions.

### 1) “8% Solids”

| | % (w:w) in solution | % (w:w) |
|---|---|---|
| Ingredient | (as is) | solids in solution |
| Gantrez S97, BF (13% soln.)* | 30.80 | 4.00 |
| Citric acid. USP | 2.000 | 2.00 |
| Polysorbate 20, NF | 2.000 | 2.00 |
| Disodium EDTA, USP** | 0.0100 | 0.01 |
| Sodium hydroxide USP/NF | 0.1328 | 0.1328 |
| Purified water | 65.057 | 91.857 |
| | | (total water) |
| Totals: | 100.00 | 100.00 |
| | | Final solution |
| | | pH = 2.5 |

### 2) “6% Solids”

| | % (w:w) in solution | % (w:w) |
|---|---|---|
| Ingredient | (as is) | solids in solution |
| Gantrez S97, BF (13% soln.)* | 23.10 | 3.003 |
| Citric acid. USP | 1.500 | 1.50 |
| Polysorbate 20, NF | 1.500 | 1.500 |
| Disodium EDTA, USP** | 0.0100 | 0.01 |
| Sodium hydroxide USP/NF | 0.0996 | 0.0996 |
| Purified water | 73.787 | 93.887 |
| | | (total water) |
| Totals: | 100.00 | 100.00 |
| | | Final solution |
| | | pH = 2.5 |

### 3) “4% Solids”

| | % (w:w) in solution | % (w:w) |
|---|---|---|
| Ingredient | (as is) | solids in solution |
| Gantrez S97, BF (13% soln.)* | 15.40 | 2.00 |
| Citric acid. USP | 1.000 | 1.00 |
| Polysorbate 20, NF | 1.000 | 1.00 |
| Disodium EDTA, USP** | 0.0100 | 0.01 |
| Sodium hydroxide USP/NF | 0.0664 | 0.06640 |
| Purified water | 82.524 | 95.923 |
| | | (total water) |
| Totals: | 100.00 | 100.00 |
| | | Final solution |
| | | pH = 2.5 |

*Gantrez is supplied according to the supplier's specification of 12-14.4 wt % solids ie 13.2 wt % nominal.
**In loading solutions containing Gantrez polymers, EDTA disodium salt at 100 ppm was included as a stabiliser for the Gantrez polymer.)

In experiments a loading solution containing up to 12% solids was made, i.e. with proportions based on the above pro-rata, and found to be workable. On the basis of these experiments loading solutions with proportionally more or less solid content appear to be feasible.

The loading solutions listed above were prepared in 160 kg batches for application to a polypropylene or polyester non-woven fabric by spraying or dipping using standard commercially available machinery, followed by drying the wetted fabric in a drying tunnel.

### Further Experiments.

Further experiments as described below were performed to investigate the anti-viral effectiveness of various acidic polymers. A polypropylene material as used in the experiments above was coated with various quantities of acidic polymers using a coating procedure analogous to that described above.

Effect of Carbopol ETD2020 and Citric Acid at Different Dosage Level at Different Exposure times.
Loading Solutions as Below were Used:

| | | | Loading | pH of | Average |
|---|---|---|---|---|---|
| | | % | Soln. | treated pp | wt % |
| Ref. | Ingredient | wt | pH | substrate. | deposited |
| 1 | Carbopol ETD 2020 | 1.0 | 2.3 | 3.17 | 6.96 |
| | Citric acid monohydrate | 0.5 | | | |
| 2 | Carbopol ETD 2020 | 2 | 2.68 | 3.20 | 16.68 |
| 3 | Carbopol ETD 2020 | 2 | 2.16 | 2.25 | 21.06 |
| | Citric acid monohydrate | 1 | | | |

Swatches of non-woven polypropylene as above were treated with these loading solutions and allowed to dry. Treated swatches (2.54 cm×2.54 cm) were exposed to Influenza A (Hong Kong Strain) in 0.2 ml water for varying times (0.5 min., 1.0 min, 5 min, 60 min.) then the solution was eluted and tested for viral activity. Results showed that all three loaded swatches killed the virus as follows, in which the Log Reduction Titer/ml is listed. A Log Reduction of 3 corresponds to a 99.9% kill of virus.

| Product Ref. | 0.5 min | 1 min. | 2 min. | 60 min |
|---|---|---|---|---|
| 1 | 3.0 | 4.1 | 4.1 | 4.1 |
| 2 | 4.1 | 4.1 | 4.1 | 4.1 |
| 3 | 3.0 | 4.1 | 4.1 | 4.1 |
| Untreated control | 0 | 0 | 0 | 0 |

It is therefore seen that all the polypropylene swatches upon which the listed acidic polymer had been deposited caused 3 or greater than 3 Log reduction in the viral titer.

### Effect of Different Acidic Polymers and Surfactants.

Loading Solutions as Below were Used:

| | Loading | Wt % | Antiviral |
|---|---|---|---|
| Loading solution | soln. pH | deposited | activity* |
| Carbopol ETD 2020 2% | 2.68 | 17.35 | 0.8 |
| Carbopol ETD 2020 2%, Citric | 2.19 | 118 | 2.6 |
| acid 1%, SLS 1% | | | |
| Carbopol ETD 2020 2%, Citric | 2.20 | 35.5 | 3.6 |
| acid 1%, Tween 20 1% | | | |
| Gantrez S-97 2% | 2.28 | 21.55 | 3.5 |
| Gantrez S-97 2%, Citric acid 1% | 2.00 | 16.31 | 2.5 |
| Gantrez S-97 2%, Tween 20 1% | 2.20 | 20.66 | 2.4 |
| Gantrez S-97 2%, Citric acid | 2.0 | 25.1 | 3.8 |
| 1%, Tween 20 1% | | | |
| Polystyrene sulphonic acid 2% | 2.20 | 13.0 | 0 |
| Copolymer of acylic acid and | 3.73 | 11.8 | 1.8 |
| sulphonic acid 2% | | | |
| Citric acid 10% | 1.60 | 36.25 | 3.6 |
| Polyacrylic acid 2% | 3.18 | 9.9 | 2.1 |
| Polymethacrylic acid | 2.16 | 7.6 | 1.2 |
| Polypropylene control | | | |

*Antiviral activity is measured as Log reduction in viral titres, vs. non-treated polypropylene control.

Swatches of non-woven polypropylene as above were treated with these loading solutions and allowed to dry as above. Treated swatches were exposed to Influenza A (Hong Kong Strain) following three days of incubation, with an exposure rime of one minute. The Log(TCID 50/0.1 ml) Avg (n=2) was measured.

It is therefore seen that all the polypropylene swatches upon which the listed acidic polymer had been deposited caused a reduction in the viral titer.

Effect of Different Acidic Polymers with Citric Acid and Tween 20 Surfactant.
Loading Solutions as Below were Used:

| | | | 1% citric | 1% Tween | 1% citric acid + |
|---|---|---|---|---|---|
| | | | acid | 20% | 1% Tween 20% |
| | Acidic | | % loading | loading pH | loading |
| Ref. | polymer | wt % | pH of soln | of solution | pH of solution |
| 4 | Carbopol | 2% | 24.67 | 46.07 | 48.00 |
| | ETD 2020 | | 2.10 | 2.86 | 2.13 |
| 5 | Gantrez S-97 | 2% | 16.31 | 20.66 | 25.13 |
| | | | 1.99 | 2.20 | 1.99 |
| 6 | Polyacrylic | 2% | 12.32 | 18.87 | 99.23 |
| | acid | | 2.31 | 3.25 | 2.27 |

The results tabulated above show the amount in wt % of the components of the loading solution which were found to be deposited onto the polypropylene swathe using the loading solution listed.

Swatches of non-woven polypropylene as above were treated with these loading solutions and allowed to dry as above. Treated swatches were exposed to Influenza A with a one minute exposure time. The Average Log Reduction (“ALR”) and Average % Reduction (A % R) (n=2) were measured and tabulated below.

| | | | 1% citric | 1% | 1% citric acid + |
|---|---|---|---|---|---|
| | | | acid | Tween 20 | 1% Tween 20 |
| | | | ALR % | ALR % | ALR % |
| Ref. | Acidic polymer | wt % | A % R % | A % R % | A % R % |
| 4 | Carbopol | 2% | 1.6 | 0.55 | 3.26 |
| | ETD 2020 | | 97.2 | 71.8 | 99.95 |
| 5 | Gantrez S-97 | 2% | 2.5 | 2.4 | 3.8 |
| | | | 99.6 | 99.6 | 99.98 |
| 6 | Polyacrylic | 2% | 2.3 | 3.8 | ≧4.8 |
| | acid | | 99.4 | 99.98 | ≧99.998 |

The titer of the input virus control was 10^{6.25}. All test substances were neutralized at a TCID₅₀ of ≦0.5 log₁₀.

These results show the level of viral neutralization that can be achieved by contact of the virus with the filter materials of this invention.

### Polyester Substrate.

Further experiments were performed using a polyester substrate material.

### Polyester Material.

The polyester material used was a proprietary nonwoven fabric made up 100% of polyester fibres, designated by its supplier 100% polyester—180 gsm (needle punching method of mechanical bonding) 90015356—NT MSQ 180G/M2 BLANC LZE MM non woven fabric. Material of various weights were used in experiments, 180, 80 and 70 g/m² The colour of the fabric was white or anthracite grey (provided by a mixture of black and white fibres). White fabric was available in widths 450, 480, 560, 670 and 930 mm, each +/−10 mm. Grey fabric was available in widths 450, 560, and 930 mm, each +/−10 mm. This fabric was available in rolls which were protected so as to be clean at delivery. The fabric was free of undesirable materials including lead, mercury, cadmium, chromium, nickel, polybromodiphenyls, polybromodiphenylethers, natural latex, proteins, silicone, phthalates and formaldehyde, and otherwise complied with EU Directive 2002/95/EC.

### Loading.

The 180 g/m² material was sprayed with the “4% solids” loading solution described above and dried by passing through a drying tunnel with an inlet hot air temperature not exceeding 180° C. The so-formed filter materials were then used as the outer layer for the moulded masks, the material of the inner layers was determined to ensure the mask met global N95 and EP standards. All masks passed NIOSH testing for particle filtration and breathability. Additionally the loaded layer showed a surface pH of 2.5-2.8 and 1 minute exposure to influenza virus (200 micro L of 10⁶ PFU Hong Kong strain) on the surface demonstrated maximum antiviral activity compared to untreated masks. Exemplary results are tabulated below.

| | | | | | Antiviral activity |
|---|---|---|---|---|---|
| Mask | | | Weight | | (Log reduction |
| lot | Particle | Breathability | gain | Surface | in viral titres vs |
| No. | Filtration | (Air Flow) | on loading | pH | uncoated. |
| 10 | Passed* | Passed* | 22% | 2.5-2.8 | >4 (=10,000 × |
| | | | | | reduction) |
| 11 | Passed* | Passed* | 19% | 2.5-2.8 | >4 |
| 12 | Passed* | Passed* | 23% | 2.5-2.8 | >4 |

*Passed limits for both NIOSH standards.

Further experiments were performed using the “6% solids” loading solution referred to above, applied by spraying or immersion to lighter polyester materials. Results are summarized below.

| | | | | | Antiviral |
|---|---|---|---|---|---|
| | | | Weight | | activity |
| Polyester | | | gain | | (Log reduction |
| weight | Particle | Breathability | on | Surface | in viral titres vs |
| g/m² m | filtration | (Air Flow) | loading | pH | uncoated. |
| 70 | Passed* | Passed* | 19.5% | 2.5-2.8 | 4.9 +/− 0.2 |
| 80 | Passed* | Passed* | 19% | 2.5-2.8 | >5.5 |
| 80 | Passed* | Passed* | 23% | 2.5-2.8 | >5.0 |

*The masks passed NIOSH N95 requirements.

Loading conditions were set to load 25-45 gm² of the solids in the loading solution, aiming at 35 gm² of such solids. Excess loading solution could be squeezed out by rollers if necessary.

It was found to be convenient to include a dye, typically blue, into the loading solution so that the colour of the dye deposited on the fabric shows that the loading solution has been applied. Using this polyester material it was noted that a higher loading % of solids was achieved than with polypropylene. Relative to polypropylene the loaded polyester material had a better visual appearance, was not sticky or slippery and less visual appearance of deposited material flaking off. This loaded material was found to be stable when stored in an unpackaged state for 9 weeks, showing only minor discolouration. This loaded material was moulded into mask shells in a conventional manner known in the art.

1. An air-permeable mask of a shape suitable to be placed over a user's mouth and nose and to sealingly contact the user's face, provided with means to hold the mask in place on the user's face, and comprising one or more layer of a filter material positioned such that inhaled and/or exhaled air of the user passes through the filter material, wherein the filter material comprises an air permeable substrate combined with an acidic polymer.

2. The mask according to claim 1 wherein the air-permeable substrate comprises a fibrous substrate.

3. The mask according to claim 2 wherein the air-permeable substrate comprises a non-woven polyester.

4. The mask according to claim 3 wherein the air-permeable substrate comprises a non-woven polypropylene.

5. The mask according to claim 1 wherein the acidic polymer comprises a poly-(carboxylic acid) polymer.

6. The mask according to claim 5 wherein the poly-(carboxylic acid) polymer includes:
—[—CR¹.COOH—]—
units in its structure, wherein R¹ is hydrogen, or R¹ may be C₁₋₃ alkyl, C₁₋₃ alkoxy or C₁₋₃ hydroxy alkyl.

7. The mask according to claim 6 wherein the acidic polymer comprises a polymer of acrylic acid or methacrylic acid.

8. The mask according to claim 7 wherein the acidic polymer comprises a homopolymer of acrylic acid crosslinked with an allyl ether.

9. The mask according to claim 6 wherein the poly-(carboxylic acid) polymer includes adjacent
—[—CR¹.COOH—]—
units in its structure.

10. The mask according to claim 9 wherein the acidic polymer is based on maleic acid moieties including —[—CH.COOH—CH.COOH—]— units, and/or salts or esters of such units, or such units in anhydride form in which COOH groups on adjacent carbon atoms are cyclised to form a —CH.CO—O—CO.CH— ring system.

11. The mask according to claim 10 wherein the acidic polymer comprises units:
—[—CH₂—CH.OCH₃—CH.COOH—CH.COOH—]—
in its structure.

12. The mask according to claim 11 wherein the acidic polymer comprises Gantrez™ S-97.

13. The mask according to claim 1 wherein the acidic polymer comprises a co-polymer of an acrylic or methacrylic acid with sulphonic acid.

14. The mask according to claim 1 wherein the acidic polymer is a linear acidic polymer.

15. The mask according to claim 1 wherein the filter material further comprises one or more organic carboxylic acid.

16. The mask according to claim 15 wherein the organic carboxylic acid is citric acid.

17. The mask according to claim 15 wherein the weight ratio of acidic polymer:organic carboxylic acid in the filter material is from about 10:1 to about 1:1.

18. The mask according to claim 17 wherein the weight ratio of acidic polymer:organic carboxylic acid in the filter material is about 2+/−0.25:1.

19. The mask according to claim 1 wherein the filter material further comprises one or more surfactant.

20. The mask according to claim 19 wherein the surfactant is a non-ionic surfactant.

21. The mask according to claim 19 wherein the weight ratio of acidic polymer:surfactant in the filter material is from about 10:1 to about 1:1.

22. The mask according to claim 21 wherein the weight ratio of acidic polymer:surfactant in the filter material is about 2+/−0.25:1.

23. An air-permeable mask of a shape suitable to be placed over a user's mouth and nose and to sealingly contact the user's face, provided with means to hold the mask in place on the user's face, and comprising one or more layer of a filter material positioned such that inhaled and/or exhaled air of the user passes through the filter material, wherein the filter material comprises an air permeable substrate combined with an acidic polymer, an organic carboxylic acid and a surfactant and wherein the total loading of the acidic polymer, the organic carboxylic acid and the surfactant on the air permeable substrate is in the range of about 20 to about 50 g/m².

24. The mask according to claim 23 wherein the total loading of the acidic polymer, the organic carboxylic acid, and the surfactant on the air permeable substrate is in the range of about 25 to about 45 g/m².

25. The mask according to claim 1 wherein the filter material comprises a linear acid polymer which comprises:
—[—CH₂—CH.OCH₃—CH.COOH—CH.COOH—]—
units in its structure, together with citric acid and a non-ionic surfactant, deposited on a non-woven polyester fibrous substrate, in the proportion weight ratio of acidic polymer:citric acid:non-ionic surfactant in the filter material is in the range of about 2+/−0.25:1:1.

26. The mask according to claim 1 comprising one or more layer of a further material, being a layer backing the filter material, or two layers sandwiching the filter material, and situated in the face mask such that when the mask is used the layer of further material is positioned between the filter material and the user's skin.

27. A filter material suitable for use in the face mask according to claim 1 comprising a fibrous substrate on which is deposited an acidic polymer which is a linear acidic polymer.

28. A filter material suitable for use in the face mask according to claim 1 comprising a fibrous substrate on which is deposited an acidic polymer which includes adjacent
—[—CR¹.COOH—]—
units in its structure wheein R¹ is hydrogen, or R¹ may be C₁₋₃ alkyl, C₁₋₃ alkoxy or C₁₋₃ hydroxy alkyl.

29. The filter material according to claim 28 wherein the acidic polymer is based on maleic acid moieties which include —[—CH.COOH—CH.COOH—]—units, and/or salts or esters of such units, or such units in anhydride form in which COOH groups on adjacent carbon atoms may be cyclised to form a —CH.CO—O—CO.CH— ring system, such derivatives being susceptible to hydrolysis to form the corresponding free acid.

30. A filter material suitable for use in the face mask according to claim 1 comprising a fibrous substrate on which is deposited an acidic polymer in combination with an organic carboxylic acid.

31. The filter material according to claim 30 wherein the acidic polymer is a linear acid polymer which comprises:
—[—CH₂—CH.OCH₃—CH.COOH—CH.COOH—]—
units in its structure, the organic carboxylic acid is citric acids, and further comprising a non-ionic surfactant, wherein the acid polymer, the organic carboxylic acid and the surfactant are deposited onto a fibrous substrate comprising a non woven polyester, in the proportion weight ratio of acidic polymer:organic carboxylic acid:surfactant is in the range 2+/−0.25:1:1.

32. The filter material according to claim 31 wherein the total loading of the acidic polymer, the carboxylic acid and the surfactant on the substrate is in the range of about 20 to about 50 g/m².

33. A process for making a face mask comprising providing a filter material as claimed in claim 27 and forming the filter material into a face mask.

34. The process for making a filter material according to claim 33 wherein the acidic polymer is incorporated in a liquid vehicle, the substrate material is wetted with the resulting liquid composition, and the liquid vehicle allowed or caused to evaporate to thereby leave the acidic polymer deposited on the substrate.

35. The process according to claim 34 wherein the liquid composition comprises from about 0.5 to about 6.0 wt % of the acidic polymer; from 0 to about 3.0 wt % organic carboxylic acid, and from 0 to about 3.0 wt % surfactant.

36. The process according to claim 35 wherein the weight ratio of acidic polymer:organic carboxylic acid:surfactant in the liquid composition is in the range of about 2+/−0.25:1:1.

37. A liquid composition suitable for use in the process according to claim 34 comprising the acidic polymer incorporated in a liquid vehicle.

38. The liquid composition according to claim 37 wherein the liquid composition comprises from about 0.5 to about 6.0 wt % of the acidic polymer; from 0 to about 3.0 wt % organic carboxylic acid, and from 0 to about 3.0 wt % surfactant.

39. The liquid composition according to claim 38 wherein the weight ratio of acidic polymer:organic carboxylic acid:surfactant in the liquid composition is in the range of about 2+/−0.25:1:1.

40. A method of removing airborne pathogens, particularly virus, from air, comprising passing air believed to be contaminated with such virus through a one or more layers of a filter material as claimed in claim 27.
